(19) United States
(12) Patent Application Publication
(10) Pub. No.: US 2020/0409393 A1
(43) Pub. Date: Dec. 31, 2020

(54) MOBILE OBJECT, REMOTE-CONTROL DEVICE, REMOTE-CONTROL SYSTEM, REMOTE-CONTROL METHOD, AND RECORDING MEDIUM HAVING REMOTE-CONTROL PROGRAM RECORDED THEREON

(71) Applicant: NEC CORPORATION, Tokyo (JP)

(72) Inventors: Taichi KUMAGAI, Tokyo (JP); Hiroshi YOSHIDA, Tokyo (JP)

(73) Assignee: NEC CORPORATION, Tokyo (JP)

(21) Appl. No.: 16/978,856

(22) PCT Filed: Mar. 18, 2019
(86) PCT No.: PCT/JP2019/011041

§ 371 Date: Sep. 8, 2020

(30) Foreign Application Priority Data
Mar. 23, 2018 (JP) 2018-055827

(51) Int. Cl. G05D 1/08; G05D 1/10; G05D 1/00; B64C 39/02; H04W 4/40

(52) U.S. Cl. CPC G05D 1/0825; G05D 1/104; G05D 1/0022; B64C 2201/14; H04W 4/40; B64C 2201/12; B64C 39/024

(57) ABSTRACT

To enable flexibly altering the configuration of an unmanned aircraft, the remote-control device is provided with: a receiving part which receives, via a communication network, sensor information transmitted from one or more mobile objects; a control unit that calculates, on the basis of the received sensor information and attitude control information that pertains to attitude control of a collective including as inputted elements at least one mobile object and that is set on the basis of configuration information pertaining to the configuration of the collective, a control manipulation quantity for manipulating the mobile objects, and generates a control signal including the control manipulation quantity; and a transmission part which transmits the generated control signal to the mobile objects.

### TECHNICAL FIELD

The present invention relates to a mobile object, a remote-control device, a remote-control system, a remote-control method, and a remote-control program that perform updating and attitude control of an attitude control device from a remote place via a communication network.

### BACKGROUND ART

In recent years, an unmanned aerial vehicle (UAV) called drone has been rapidly spread. The unmanned aerial vehicle has been put into practice in various fields such as disaster countermeasures, surveying, agriculture, infrastructure inspection, or logistics.

The unmanned aerial vehicle autonomously flies, while controlling an attitude of the own vehicle by being provided with a gyro sensor, an acceleration sensor, a global positioning system (GPS), an attitude control device, and the like.

PTL 1 discloses a method in which a drone autonomously performs attitude control for ascending/descending/horizontal movement according to a flight route being set in advance.

PTL 2 discloses an unmanned aerial vehicle in which a predetermined positional relation (formation) is formed among a plurality of unmanned aerial vehicles by autonomously generating and executing a control command for adjusting a relative positional relation among the unmanned aerial vehicles. Such an unmanned aerial vehicle acquires position information and speed information of each vehicle other than the own vehicle by wireless communication, and autonomously performs attitude control in such a way that a predetermined positional relation is maintained among the vehicles, based on these pieces of position information and speed information.

PTL 3 discloses a method in which an unmanned aerial vehicle (surveillance vehicle) having an image capturing function captures an image of an unmanned aerial vehicle (manipulation target vehicle) being a control target, and an operator remotely manipulates the manipulation target vehicle, while watching a captured flight video of the manipulation target vehicle. The surveillance vehicle has a companion flight function of autonomously hovering around the manipulation target vehicle, and a function of distributing, to a terminal held by the operator, a captured video via a wireless communication network. The manipulation target vehicle moves in accordance with an instruction (a flight direction and a flight altitude) of the operator, while autonomously controlling an attitude of the own vehicle.

NPL 1 discloses four unmanned aerial vehicles mounted in such a way that one vehicle is mounted on each of left and right sides of a backrest upper portion of a folding chair, and one vehicle is mounted at each of positions near both ends of a front side of a seat thereof via a mounting unit. These four unmanned aerial vehicles can transport the folding chair, as one unmanned aerial vehicle in which the folding chair functions as a body frame, by controlling an attitude by an attitude control device provided beneath the seat of the folding chair in such a way that each of the vehicles autonomously cooperate with one another.

### CITATION LIST

### Patent Literature

[PTL 1] Japanese Patent No. 5999537
[PTL 2] Japanese Unexamined Patent Application Publication No. 2004-025971
[PTL 3] Japanese Patent No. 6100868
[PTL 4] International Publication No. WO2017/006421
[PTL 5] Japanese Unexamined Patent Application Publication No. 2016-174360

### Non Patent Literature

[NPL 1] Prodrone Co., Ltd., product name “ANYDRONE”, [online] [retrieved on Jun. 5, 2017], Internet <URL: https//www.prodrone.jp/concept/pd-any>

### SUMMARY OF INVENTION

### Technical Problem

For example, when an unmanned aerial vehicle is used for transporting goods, the unmanned aerial vehicle is needed to transport various types of transport goods in which a size, a shape, and a weight are different. Then, the unmanned aerial vehicle is needed to alter a configuration of the own vehicle such as a size of a vehicle body, the number of propellers (also referred to as rotors) to be loaded, a battery capacity, and the number of vehicles for use according to various types of transport goods. When the configuration of the own vehicle is altered, the unmanned aerial vehicle is needed to perform an updating operation of an attitude control device according to the alteration of the configuration of the own vehicle in such a way that the unmanned vehicle can stably fly.

However, since the unmanned aerial vehicles disclosed in PTLs 1 to 3 and NPL 1 are loaded with an attitude control device for autonomously performing attitude control, an updating operation of the attitude control device is needed at a place where the unmanned aerial vehicle is installed. Further, the updating operation of the attitude control device of the unmanned aerial vehicle is needed to be performed by personnel having expertise. Therefore, it is necessary to constantly secure such personnel at a place where the unmanned aerial vehicle is installed in order to perform the updating operation of the attitude control device.

In order to cope with these matters, a method is proposed in which a plurality of types of unmanned aerial vehicles are prepared in advance, and an unmanned aerial vehicle is preferentially used according to various types of transport goods in such a way as not to alter the configuration of the unmanned aerial vehicle. However, such a method may cause an increase in transportation cost by the unmanned aerial vehicle.

In view of the above, an object of the present invention is to provide a mobile object, a remote-control device, a remote-control system, a remote-control method, and a remote-control program that are capable of flexibly altering a configuration of an unmanned aerial vehicle at a remote place by long-distance communication via a communication network including the Internet and the like.

### Solution to Problem

A remote-control device according to the present invention includes: a receiving part that receives sensor information to be transmitted from at least one mobile object via a communication network; a control unit that calculates a control manipulation quantity for manipulating the mobile object, based on attitude control information pertaining to attitude control of a collective, which is set based on configuration information pertaining to a configuration of the collective in which the at least one mobile object to be input is an element, and the received sensor information, and generates a control signal including the control manipulation quantity; and a transmission part that transmits the generated control signal to the mobile object.

A mobile object according to the present invention includes a sensor unit that acquires sensor information, a wirelessly communicable communication unit that transmits the sensor information, and receives a control signal, and a driving control unit that controls a drive unit, based on the received control signal.

A remote-control system according to the present invention includes: a remote-control device; and a mobile object that communicates with the remote control device via a communication network.

A remote-control method according to the present invention includes: receiving sensor information to be transmitted from at least one mobile object via a communication network; calculating a control manipulation quantity for manipulating the mobile object, based on attitude control information pertaining to attitude control of a collective, which is set based on configuration information pertaining to a configuration of the collective in which the at least one mobile object to be input is an element, and the received sensor information, and generating a control signal including the control manipulation quantity; and transmitting the generated control signal to the mobile object.

A remote-control program according to the present invention causes a computer to execute: processing of receiving sensor information to be transmitted from at least one mobile object via a communication network; processing of calculating a control manipulation quantity for manipulating the mobile object, based on attitude control information pertaining to attitude control of a collective, which is set based on configuration information pertaining to a configuration of the collective in which the at least one mobile object to be input is an element, and the received sensor information, and generating a control signal including the control manipulation quantity; and processing of transmitting the generated control signal to the mobile object.

### Advantageous Effects of Invention

The present invention provides an advantageous effect that it is possible to flexibly alter a configuration of an unmanned aerial vehicle.

### BRIEF DESCRIPTION OF DRAWINGS

FIG. 1 is a block diagram illustrating an overview of a remote-control system 1 according to a first example embodiment of the present invention.

FIG. 2 is a block diagram illustrating a configuration example of the remote-control system 1 according to the first example embodiment of the present invention.

FIG. 3 is a block diagram illustrating a configuration example of a mobile object 40 according to the first example embodiment of the present invention.

FIG. 4 is a schematic diagram illustrating a configuration example of a control target device 50 according to the first example embodiment of the present invention.

FIG. 5 is a flowchart schematically illustrating an updating operation of an attitude control program of the mobile object 40 according to the first example embodiment of the present invention.

FIG. 6 is a flowchart schematically illustrating an attitude control operation of the mobile object 40 according to the first example embodiment of the present invention.

FIG. 7 is a flowchart schematically illustrating an operation of the mobile object 40 according to the first example embodiment of the present invention.

FIG. 8 is a block diagram illustrating a configuration example of a remote-control system 2 according to a second example embodiment of the present invention.

FIG. 9 is a flowchart schematically illustrating transmission of sensor information of a mobile object 60 according to the second example embodiment of the present invention.

FIG. 10 is a flowchart schematically illustrating reception of a control signal including a control manipulation quantity of the mobile object 60 according to the second example embodiment of the present invention.

FIG. 11 is a block diagram illustrating a configuration example of a remote-control system 3 according to a third example embodiment of the present invention.

FIG. 12 is a block diagram illustrating a configuration example of an information processing device for achieving a functional unit of each constituent element of each device according to each of the example embodiments of the present invention.

### EXAMPLE EMBODIMENT

In the following, example embodiments according to the present invention are described with reference to the drawings. When reference signs are appended in the drawings in the present application, they are provided exclusively for aiding comprehension of the present invention, and do not intend that the present invention is limited to the illustrated configuration. The following example embodiments are merely an example, and do not limit the present invention.

### (1) First Example Embodiment

### [Configuration of Remote-Control System]

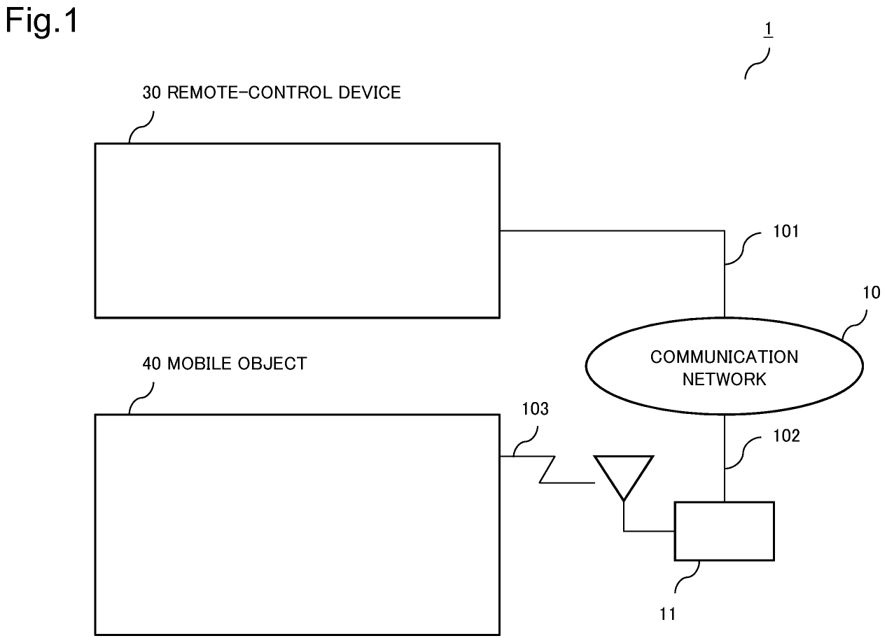

A remote-control system 1 according to a first example embodiment is described with reference to the drawings. FIG. 1 is a block diagram illustrating an overview of the remote-control system 1 according to the first example embodiment.

As illustrated in FIG. 1, the remote-control system 1 includes a remote-control device 30, a mobile object 40, and a communication network 10 to be connected to a wireless base station device 11. The remote-control system 1 is a system for remotely controlling the attitude of the mobile object 40 capable of wirelessly communicating with the wireless base station device 11 via the communication network 10 from the remote-control device 30. Although FIG. 1 illustrates only one mobile object 40 and only one wireless base station device 11, the numbers of these elements are not necessarily limited. For example, a plurality of mobile objects 40 and a plurality of wireless base station devices 11 may be present in the remote-control system 1.

### [Configuration of Communication Network]

The communication network 10 wirelessly communicably connects the remote-control device 30 and the mobile object 40. The communication network 10 is communicably connected to the remote-control device 30 via a wired link 101. The communication network 10 includes the wireless base station device 11, which is communicably connected to another element (not illustrated) in the communication network 10 via a wired link 102.

The wireless base station device 11 is a device for providing a wireless communication service to a wireless terminal having a wireless communication function. The wireless base station device 11 is wirelessly communicably connected to the mobile object 40 via a wireless link 103. In the communication network 10, the entirety or a part of a link other than the wireless link 103 that wirelessly connects the wireless base station device 11 and the mobile object 40 may be a wireless link or a wired link.

### [Configuration of Remote-Control Device]

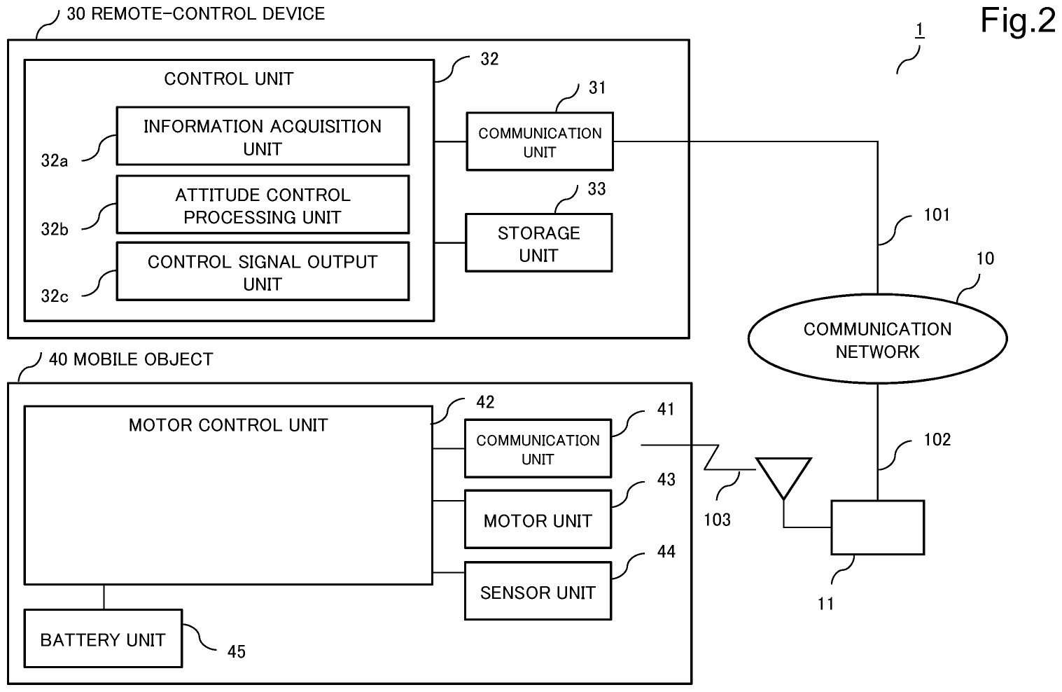

A configuration of the remote-control device 30 is described with reference to FIG. 2. FIG. 2 is a block diagram illustrating a configuration example of the remote-control system 1. The remote-control device 30 is a device for remotely performing attitude control of the mobile object 40 via the communication network 10. In view of the above, the remote-control device 30 may be installed at a remote place far from the mobile object 40. In the present invention, it is assumed that attitude control means an operation during flight of a collective (also referred to as unmanned aerial vehicles) being a mobile object or a control target object to be described later, and, for example, includes ascending/descending movement and hovering.

The remote-control device 30 includes a communication unit 31, a control unit 32, and a storage unit 33. The control unit 32 performs processing such as control of the communication unit 31 and the storage unit 33, and attitude control of the mobile object 40.

The communication unit 31 performs reception of sensor information to be acquired from various types of sensors provided in the mobile object 40, and transmission of a control signal and the like pertaining to motor control of a motor unit 43 to be described later.

The storage unit 33 performs reading and writing of a program, a software, data, a file, and the like. The storage unit 33 stores information (hereinafter, information pertaining to a configuration of a collective is referred to as configuration information) pertaining to a configuration of a collective (equivalent to a control target object 50 to be described later) including at least one mobile object 40, information (hereinafter, information pertaining to attitude control of the collective is referred to as attitude control information) pertaining to attitude control of the collective in which information (hereinafter, information pertaining to attitude control of a mobile object is referred to as an attitude control parameter) pertaining to attitude control of each of the mobile objects 40 is set in such a way that the collective is controllable as a single unit, based on the configuration information, an attitude control program, and the like.

Setting of the attitude control information of the collective, and the attitude control parameter of each of the mobile objects 40 may be performed by personnel having expertise arranged at a place where the remote-control device 30 is installed, based on the acquired configuration information of the collective.

The control unit 32 includes an information acquisition unit 32a, an attitude control processing unit 32b, and a control signal output unit 32c.

The information acquisition unit 32a acquires the sensor information of the mobile object 40 from the communication unit 31, and the attitude control information of the collective from the storage unit 33. The information acquisition unit 32a transmits these acquired pieces of information to the attitude control processing unit 32b. The sensor information includes attitude information indicating the attitude of the mobile object 40, GPS position information, rotation information of a motor in the motor unit 43, and battery information of a battery unit 45.

The attitude information includes at least one of an angular velocity, an angular acceleration, and a tilt angle around each of a roll axis, a pitch axis, and a yaw axis of the mobile object 40; and an acceleration and a direction of the mobile object 40. The GPS position information includes, for example, at least one of a current location and a current altitude of the mobile object 40. The rotation information of the motor includes, for example, at least one of a rotational speed, a torque, and a load of the motor. The battery information includes, for example, at least one of a battery level and a battery voltage.

The attitude control processing unit 32b is configured to determine a current location of the mobile object 40 from the acquired GPS position information, and determine a current attitude of the mobile object 40 from the attitude information. The attitude control processing unit 32b is configured to determine a rotational speed, a torque, a load, and the like of the motor from the acquired rotation information of the motor, and determine a battery level, a battery voltage, and the like from the battery information.

The attitude control processing unit 32b calculates a control manipulation quantity for manipulating each of the mobile objects 40 to perform attitude control of the collective by using the sensor information acquired from the mobile object 40 by the information acquisition unit 32a, and the attitude control parameter of each of the mobile objects 40 included in the attitude control information of the collective. Specifically, the attitude control processing unit 32b compares desired attitude information (control target value) of the mobile object 40, and current attitude information of the mobile object 40, which is a result of application of a control manipulation quantity that is calculated last time (in the present embodiment, a rotational speed of the motor). Subsequently, the attitude control processing unit 32b calculates the control manipulation quantity in such a way that a deviation between the control target value and the current attitude information of the mobile object 40 decreases. In the present embodiment, the control manipulation quantity is calculated by employing a well-known feedback control method such as proportional-integral-differential (PID) control. However, the method is not limited to such a feedback control method. The control manipulation quantity may be calculated by employing another control method.

The control signal output unit 32c generates a control signal including the control manipulation quantity calculated by the attitude control processing unit 32b, and outputs the control signal to the communication unit 31.

The communication unit 31 transmits, to the mobile object 40, the output control signal including the control manipulation quantity via the communication network 10.

### [Configuration of Mobile Object]

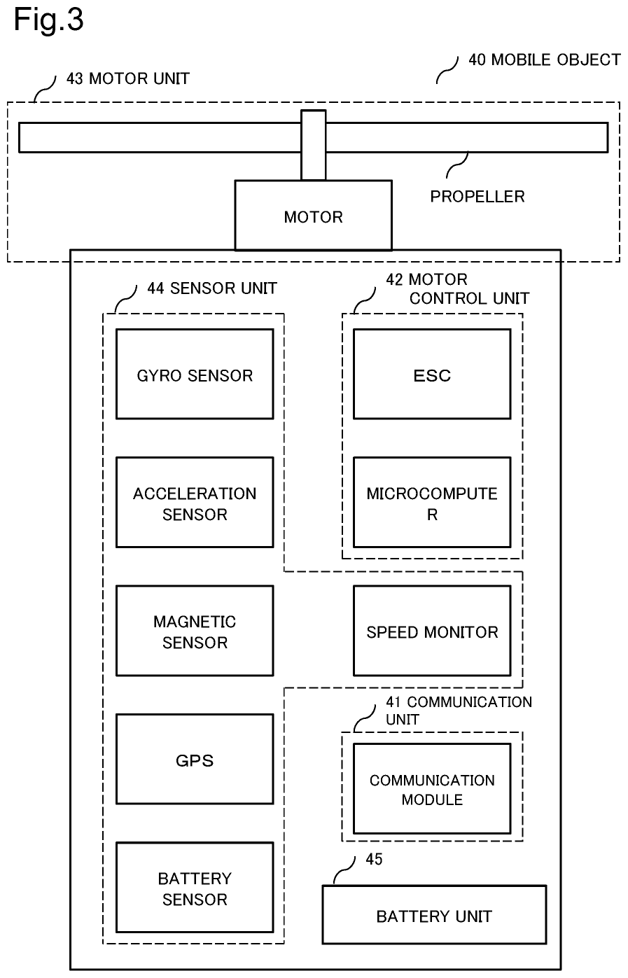

A configuration of the mobile object 40 is described with reference to FIG. 3. FIG. 3 is a block diagram illustrating a configuration example of the mobile object 40. The attitude of the mobile object 40 is controlled from the remote-control device 30 via the communication network 10.

The mobile object 40 includes a communication unit 41, a motor control unit 42, the motor unit 43, a sensor unit 44, and the battery unit 45.

The communication unit 41 is wirelessly communicably connected to the wireless base station device 11. The communication unit 41 performs, with respect to the remote-control device 30, transmission of the sensor information to be acquired by the sensor unit 44 to be described later, and reception of the control signal including the control manipulation quantity calculated by the attitude control processing unit 32b.

The communication unit 41 includes a communication module. As the communication module, a communication module in accordance with the Wi-Fi (registered trademark) may be used, and a communication module using a mobile phone network such as the 5-th generation mobile communication system (5G), the Long Term Evolution (LTE), and the Worldwide Interoperability for Microwave Access (WiMAX) may also be used.

The motor control unit 42 includes a microcomputer, and an electronic speed controller (ESC). The motor control unit 42 is configured to perform control of the motor unit 43 by the microcomputer. The motor control unit 42 may be configured in such a way that the microcomputer also performs control of the communication unit 41, the sensor unit 44, the battery unit 45, and a storage unit 46.

The motor control unit 42 processes the control signal including the control manipulation quantity input from the communication unit 41 by the ESC. The motor control unit 42 controls in such a way that a rotational speed of the motor in the motor unit 43 coincides with a rotational speed indicated by the control manipulation quantity, based on the processed control signal including the control manipulation quantity.

The motor unit 43 includes a motor and a propeller. The rotational speed of the motor is controlled by inputting an electric signal based on the control signal including the control manipulation quantity from the ESC of the motor control unit 42. Thus, the motor unit 43 alters the rotational speed of the motor to the rotational speed indicated by the control manipulation quantity. By alteration of the rotational speed of the motor, a thrust force of the mobile object 40 is altered, and the attitude of the mobile object 40 is controlled.

The sensor unit 44 includes a gyro sensor, an acceleration sensor, a magnetic sensor, a GPS, a speed monitor of the motor, and a battery sensor. The sensor unit 44 may include, as other sensors, a barometric pressure sensor, an ultrasonic sensor, an infrared sensor, a torque sensor of the motor, and the like.

In the present example embodiment, the sensor unit 44 acquires attitude information indicating a current attitude of the mobile object 40 by the gyro sensor, the acceleration sensor, the magnetic sensor, and the GPS. The sensor unit 44 acquires rotation information of the motor indicating a rotational speed of the motor by the speed monitor of the motor. The sensor unit 44 acquires battery information indicating a voltage and a level of a battery necessary for driving the motor and control equipment by the battery sensor.

In the sensor unit 44, the attitude information, the rotation information of the motor, the GPS position information, and the battery information acquired from the sensors are transmitted to the communication unit 41, as the sensor information.

The battery unit 45 supplies electric power necessary for operating the mobile object 40.

The example embodiment according to the present invention is described by using a plurality of mobile objects 40, each of which has one motor and one propeller, as illustrated in FIG. 3. The example embodiment, however, is not limited to the above. It is possible to freely alter the number of motors and the number of propellers according to a purpose of use. In the example embodiment according to the present invention, the control target device 50 (collective) having any number of propellers is configured by using any number of mobile objects 40 and a transport target object 51, and the entirety of the control target device 50 is controlled as one unit.

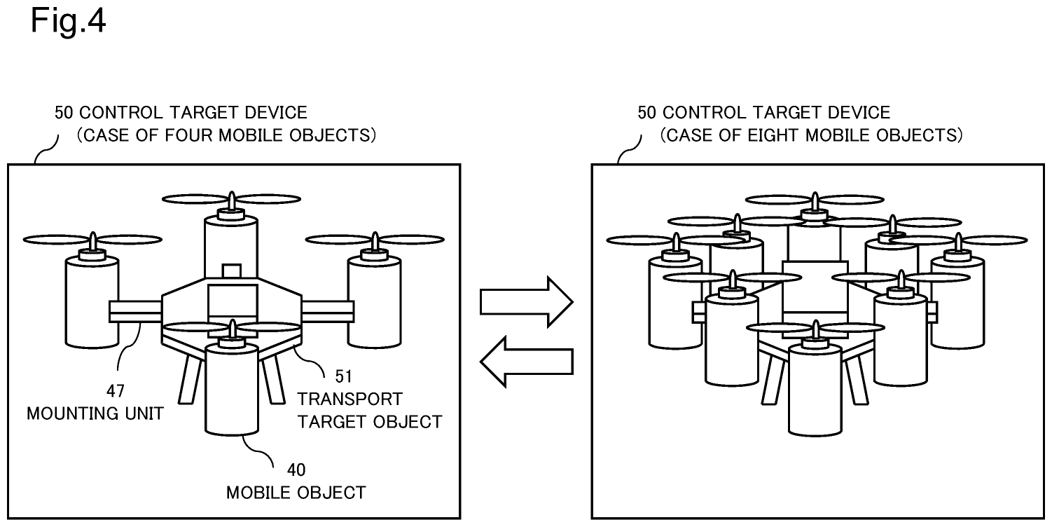

FIG. 4 is an image diagram illustrating a configuration example of the control target device 50 according to the present example embodiment. In the control target device 50, attitude control information pertaining to attitude control of an own vehicle is set according to configuration information of the own vehicle (such as the number of mobile objects 40 and a position (relative position) of each of the mobile objects 40, and a size and a weight of the transport target object 51), and an attitude control parameter of each of the mobile objects 40 is appropriately updated, based on the attitude control information. Thus, the remote-control device 30 is able to perform attitude control by cooperating the mobile objects 40 with one another, and is able to control the control target device 50 like a single unit.

As illustrated in FIG. 4, each of the mobile objects 40 constituting the control target device 50 may be configured in such a way that the own vehicle is mountable on the transport target object 51 by using a mounting unit 47. The mounting unit 47 is constituted of, for example, a locking mechanism of hooking and locking to the transport target object 51, a nipping mechanism of nipping a part of the transport target object, a screw fixing mechanism of connecting and screw fixing to the transport target object 51, and an adhesion mechanism of adhering to the transport target object 51, and the like.

### [Operation of Remote-Control Device]

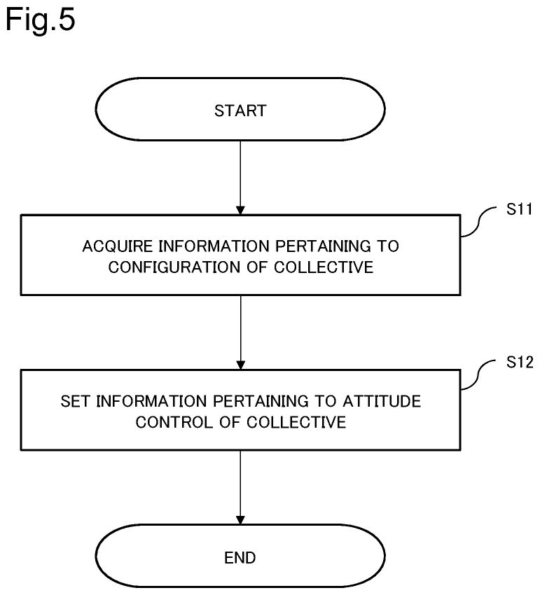

An operation of the remote-control device 30 in the remote-control system 1 according to the first example embodiment is described with reference to the drawings. FIG. 5 is a flowchart schematically illustrating an updating operation of the attitude control information of the control target device 50 including any number of mobile objects 40 in the remote-control device 30.

The remote-control device 30 acquires configuration information of the control target device 50 being a collective, and stores the configuration information in the storage unit 33 (Step S11). This configuration information includes the number of mobile objects 40 and a position (relative position) of each of the mobile objects 40, a size and a weight of the transport target object 51, and the like. The configuration information of the control target device 50 may be input from an input device such as terminal equipment, which is connected to the remote-control device 30 via the communication network 10, or may be input from an unillustrated input unit of the remote-control device 30.

Then, attitude control information of the control target device 50 in which an attitude control parameter of each of the mobile objects 40 is set is set in such a way that the control target device 50 including the plurality of mobile objects 40 is controllable as a single mobile object, based on the input configuration information of the control target device 50, and the attitude control information is stored in the storage unit 33 (Step S12). This attitude control parameter includes a coefficient pertaining to increase and decrease of a rotational speed of a motor in each of the mobile objects 40, which pertains to a control manipulation quantity, when the control target device 50 is turned clockwise or counterclockwise around each of the roll axis, the pitch axis, and the yaw axis.

Setting an attitude control parameter of each of the mobile objects 40 in the attitude control information of the control target device 50 may be such that, when a mounting position of each of the mobile objects 40 is set in advance, similarly to the control target device 50 illustrated in FIG. 4, for example, a set of attitude control parameters according to the number and the mounting positions of the mobile objects 40 to be mounted is generated in advance, and an attitude control parameter of each of the mobile objects 40 that coincides with the configuration information of the control target device 50 acquired by the remote-control device 30 is selected from among the set. Further, in such a case, as far as a size and a weight of the transport target object 51 are determined, a set of attitude control parameters taking into consideration the transport target object 51 may be generated in advance.

In setting an attitude control parameter of each of the mobile objects 40 as described above, when the mobile object 40 is directly mounted on the transport target object 51 having a complicated shape via the mounting unit 47, a relative position of an adjacent mobile object 40 may be measured by using an infrared sensor and the like, and the relative position may be transmitted to the remote-control device 30 and stored in the storage unit 33.

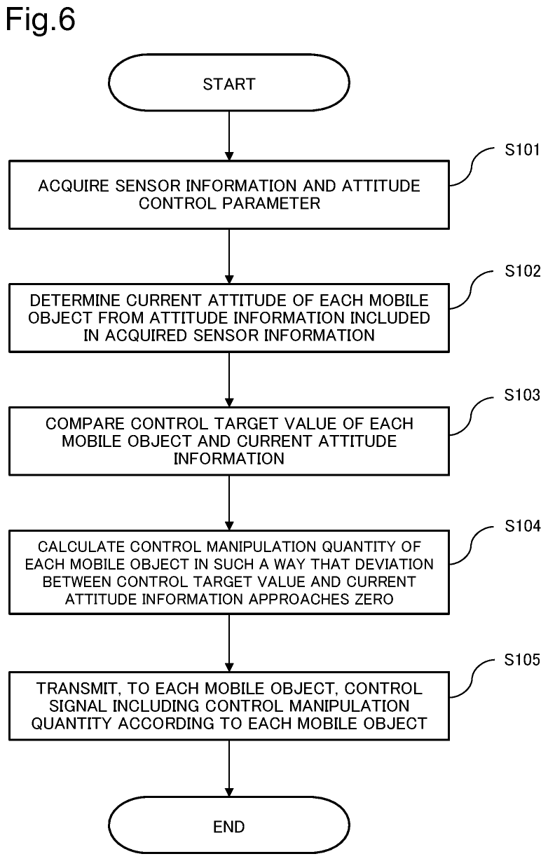

FIG. 6 is a flowchart schematically illustrating an attitude control operation of the mobile object 40 constituting the control target device 50.

The information acquisition unit 32a of the remote-control device 30 acquires each of sensor information and an attitude control parameter of each of the mobile objects 40 (Step S101). The information acquisition unit 32a acquires, as the sensor information, attitude information indicating the attitude of each of the mobile objects 40, GPS position information, rotation information of the motor unit 43, and battery information of the battery unit 45.

The attitude control processing unit 32b of the remote-control device 30 determines a current attitude of each of the mobile objects 40 from the attitude information included in the acquired sensor information (Step S102).

The attitude control processing unit 32b compares a control target value being a desired attitude of each of the mobile objects 40, and current attitude information included in the acquired sensor information (Step S103). The control target value being the desired attitude is set, for example, in such a way that it is possible to perform attitude control of the control target device 50 constituted of the mobile objects 40 as a single unit, like a drone being a single unit including a plurality of propellers and a plurality of motors.

The control target value of each of the mobile objects 40 as described above is determined by an attitude control program according to a desired operation of the control target device 50. For example, in the control target device 50, the control target value indicates a value of attitude information of each of the mobile objects 40 necessary for hovering at a predetermined position, and a value of attitude information of each of the mobile objects 40 necessary when being moved in a specific direction. In the present example embodiment, description is made based on a premise that an operation of the control target device 50 such as hovering or moving in a specific direction is determined in advance, specifically, a control target value is determined.

The attitude control processing unit 32b calculates a control manipulation quantity for controlling the attitude of each of the mobile objects 40 by using an attitude control parameter of each of the mobile objects 40 in such a way that a deviation between the control target value being the desired attitude and the current attitude information, which is a comparison result in Step S103, approaches zero (Step S104).

The control target value and the control manipulation quantity for performing attitude control of each of the mobile objects 40 as described above may be calculated by using a well-known attitude control program (or a flight control program) such as Dronecode developed in an open source, Cleanflight, Baseflight, and OpenPilot.

In the example embodiment according to the present invention, it is assumed that the control manipulation quantity is a rotational speed of the motor in the motor unit 43. The example embodiment, however, is not limited to the above. The control manipulation quantity may be a value other than the rotational speed of the motor. Further, a plurality of values may be included as the control manipulation quantity. Specifically, the control manipulation quantity may include a plurality of values, for example, include a torque value of the motor, in addition to the rotational speed of the motor.

The control signal output unit 32c generates a control signal including the control manipulation quantity according to each of the mobile objects 40, and outputs the control signal to the communication unit 31. The communication unit 31 transmits the generated control signal to each of the mobile objects 40 via the communication network 10 (Step S105). The control signal output unit 32c may output, to the communication unit 31, a control signal of the motor including the control manipulation quantity with respect to each of the mobile objects 40 at a predetermined cycle, or at the time of acquiring sensor information from each of the mobile objects 40.

The control unit 32 of the remote-control device 30 repeats the processing of Step S101 to Step S105.

The attitude control processing unit 32b may be configured to calculate a value as the attitude of the control target device 50 by using an average value or a median value of values of attitude information of the mobile objects 40. The attitude control processing unit 32b may be configured to calculate a value as the attitude of the control target device 50 by eliminating a maximum value, a minimum value, or an abnormal value being greatly deviated from other values among values of attitude information of the mobile objects 40, and using an average value or a median value of the values of attitude information of the mobile objects 40.

The attitude control processing unit 32b may determine whether a current attitude of each of the mobile objects 40 lies within an allowable range at the time of determining the current attitude of each of the mobile objects 40 in Step S102, and perform error processing when the determination result is deviated from the allowable range. The allowable range of attitude is a range within which a current attitude of mobile object 40 is allowed. The allowable range of attitude can be achieved by setting a maximum value regarding a tilt angle around each of the roll axis, the pitch axis, and the yaw axis of the mobile object 40, for example. The allowable range of attitude may be set by using a value that is determined as a specified value, or taking into consideration a purpose of use, the weather, a transport target object, and the like at the time of updating the attitude control device.

The attitude control processing unit 32b may perform re-setting of an attitude control parameter of each of the mobile objects 40, as error processing. As re-setting of the attitude control parameter of each of the mobile objects 40, a method is exemplified in which a set of attitude control parameters of each of the mobile objects 40 is stored in advance in the storage unit 33, when the number of propellers differs (such as four, six, and eight) in a configuration of the control target device 50, the set is automatically switched according to a condition, and the like. As a cause of an occurrence of such an error, for example, an environmental change (change such as a wind velocity) around the mobile object 40, a displacement of the centroid of transport goods (such as unbalanced goods, and collapse of goods), a bad condition or a stoppage of the motor, and the like are exemplified.

The attitude control processing unit 32b may determine whether a current location is within an allowable range by using the current location, in place of a current attitude of each of the mobile objects 40 depending on a purpose of use, and the like. Also, in this case, the attitude control processing unit 32b may perform re-setting of an attitude control parameter of each of the mobile objects 40, as error processing.

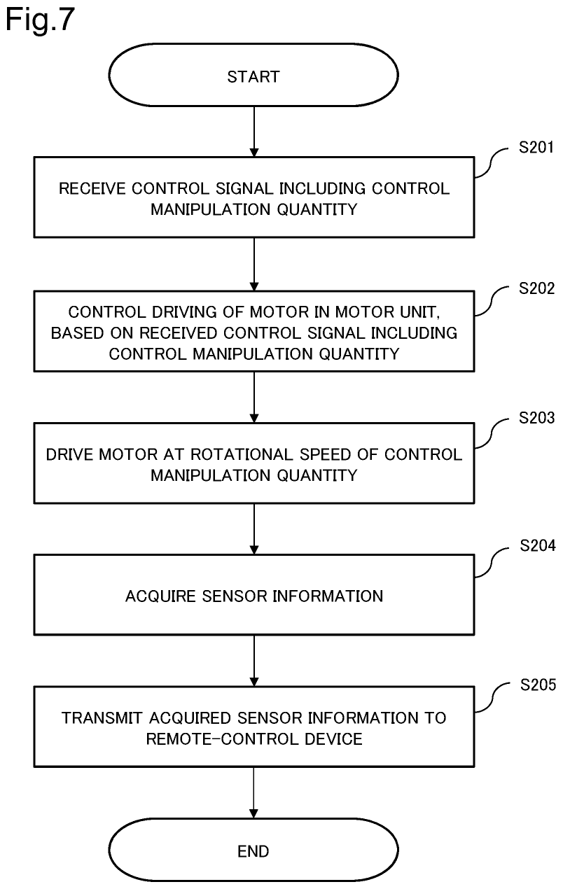

An operation of the mobile object 40 in the remote-control system 1 according to the first example embodiment is described with reference to the drawings. FIG. 7 is a flowchart schematically illustrating an operation of the mobile object 40 in the remote-control system 1 according to the first example embodiment.

### [Operation of Mobile Object]

The communication unit 41 of the mobile object 40 receives a control signal including a control manipulation quantity from the remote-control device 30 via the communication network 10 (Step S201). The motor control unit 42 inputs, to the ESC, the control signal including the control manipulation quantity received by the communication unit 41, and controls driving of the motor in the motor unit 43 by the ESC (Step S202). The motor is driven at a rotational speed of the control manipulation quantity received from the remote-control device 30 (Step S203).

The sensor unit 44 acquires measured sensor information of the mobile object 40 (Step S204). Acquisition of the sensor information indicating an operation state of the mobile object 40 is not limited after Step S201, and may be performed before Step S201 or concurrently in Step S201. Acquisition of the sensor information may be performed at a predetermined cycle, or in response to an instruction from the motor control unit 42.

The communication unit 41 transmits the acquired sensor information to the remote-control device 30 (Step S205).

The remote-control device 30 according to the present example embodiment is able to perform updating of an attitude control parameter and attitude control of each of the mobile objects 40 constituting the control target device 50 in the remote-control device 30, since the remote-control device 30 includes configuration information of the control target device 50, and attitude control information of the control target device 50 in which an attitude control parameter of each of the mobile objects 40 is set in such a way that the control target device 50 is controllable as a single unit, based on the configuration information. Therefore, as illustrated in FIG. 4, it is possible to update, from the remote-control device 30 located at a remote place, the attitude control parameter of each of the mobile objects 40 according to a configuration of the control target device 50, for example, by using four mobile objects 40 as the control target device 50, when the transport target object 51 is relatively compact and light, and by using eight mobile objects 40 as the control target device 50, when the transport target object 51 is relatively large and heavy. By configuring as described above, the remote-control system 1 can flexibly alter the configuration of the control target device 50, specifically, the number, the mounting positions, and the like of the mobile objects 40 according to a size, a weight, and a shape of the transport target object 51, without constantly arranging personnel having expertise at a place where the mobile object 40 is installed.

In the present example embodiment, even when an environmental change or contingency occurs during flight of the mobile object 40, it is possible to perform re-setting of an attitude control device according to the environment change or the contingency by the remote-control device 30, since the attitude control device such as an attitude control program and an attitude control parameter of the mobile object 40 is present in the remote-control device 30.

In the above-described configuration, it is possible to flexibly alter the configuration of the control target device 50 being a collective in which the mobile object 40 is an element, and it is possible to reduce the cost and time required for securing personnel having expertise.

In the present example embodiment, constituting the control target device 50 of any number of mobile objects 40 enables alteration of the number and the mounting positions of the mobile objects 40 constituting the control target device 50 according to a size, a shape, a weight, and the like of the transport target object 51. Therefore, it is possible to achieve a flexible configuration according to the transport target object 51, and it is possible to reduce the transportation cost by preparing a plurality of mobile objects 40 of a same type, without the need of preparing mobile objects of different types in advance.

### (2) Second Example Embodiment

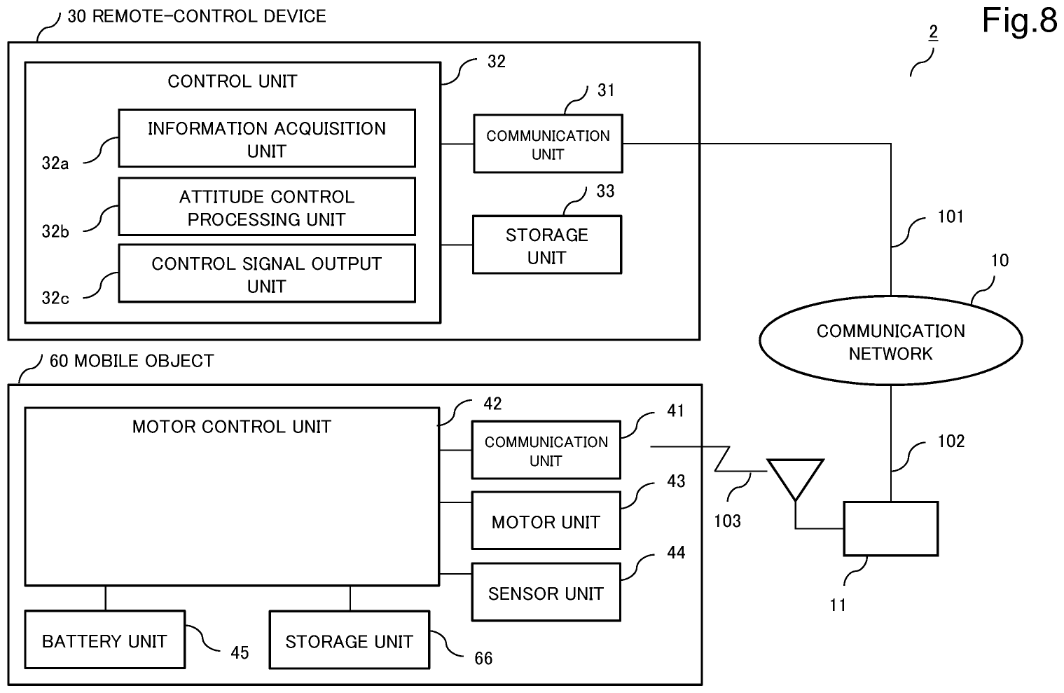

A second example embodiment is described with reference to the drawings. FIG. 8 is a block diagram illustrating a configuration example of a remote-control system 2 according to the second example embodiment of the present invention.

The first example embodiment is configured in such a way that each of the mobile objects 40 transmits sensor information to the remote-control device 30. In contrast, in the second example embodiment, a mobile object 60 includes a storage unit 66, and one of any number of mobile objects 60 constituting a control target device 70 is set as a first mobile object 61, and the rest thereof are set as second mobile objects 62.

Each of the second mobile objects 62 transmits sensor information of the own vehicle to the first mobile object 61. The first mobile object 61 stores the received sensor information of the second mobile objects 62 in the storage unit 66, and transmits all the pieces of received sensor information to a remote-control device 30.

The first mobile object 61 receives a control signal including a control manipulation quantity with respect to each of the second mobile objects 62, which is transmitted from the remote-control device 30, and stores the control signals in the storage unit 66. Thereafter, the first mobile object 61 transmits, to each of the second mobile objects 62, the control signals including the control manipulation quantities. Specifically, the remote-control device 30 according to the second example embodiment performs wireless communication only with the first mobile object 61.

Since the other configuration is similar to the configuration according to the first example embodiment illustrated in FIGS. 1 to 4, associated constituent elements are indicated with same reference signs as those in FIGS. 1 to 4, and description thereof is omitted.

Since an operation of the remote-control device 30 according to the second example embodiment is also similar to the operation according to the first example embodiment except for an operation that wireless communication is performed only with the first mobile object 61, description thereof is omitted.

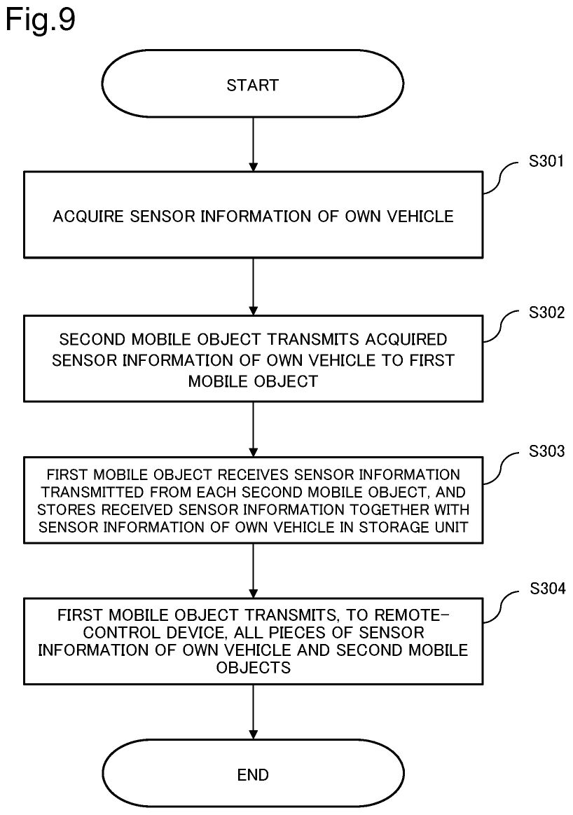

FIG. 9 is a flowchart schematically illustrating transmission of sensor information of the mobile object 60 according to the second example embodiment. The first mobile object 61 and the second mobile object 62 may be generically referred to as the mobile objects 60.

The mobile object 60 acquires sensor information of the own vehicle from a sensor unit 44 (Step S301). The second mobile object 62 transmits, to the first mobile object 61, the acquired sensor information of the own vehicle (Step S302).

The first mobile object 61 receives the sensor information transmitted from each of the second mobile objects 62, and stores the sensor information together with the sensor information of the own vehicle in the storage unit 66 (Step S303). Then, the first mobile object 61 transmits, to the remote-control device 30, all the pieces of sensor information of the own vehicle and the second mobile objects 62 (Step S304).

Acquisition of the sensor information from the second mobile objects 62 may be performed at a predetermined cycle, or by the first mobile object 61 that has received an instruction from the remote-control device 30, in response to an instruction to each of the second mobile objects 62 using broadcast communication to be described later, short-range wireless communication, and the like.

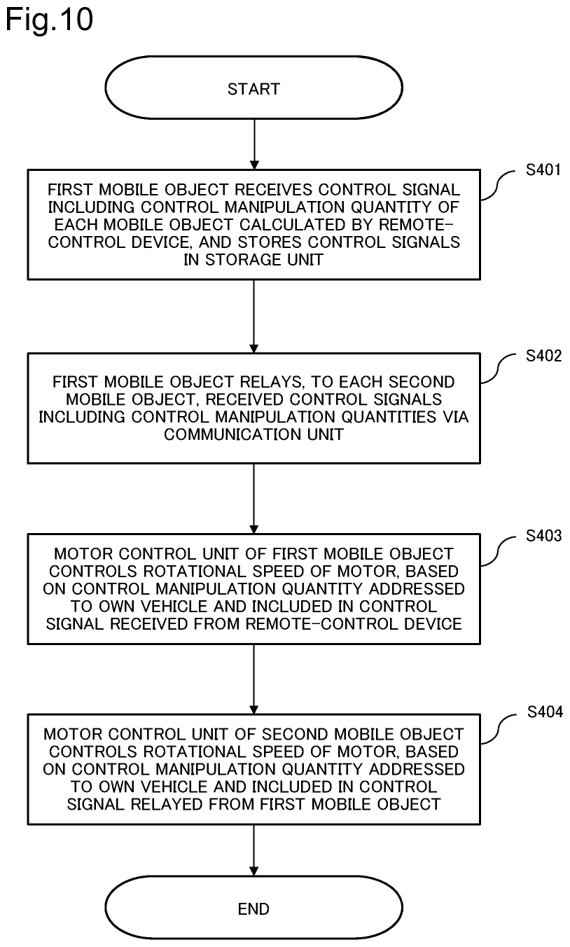

FIG. 10 is a flowchart schematically illustrating reception of a control signal including a control manipulation quantity of the mobile object 60 according to the second example embodiment.

The first mobile object 61 receives a control signal including a control manipulation quantity of each of the mobile objects 60 calculated by the remote-control device 30, and stores the control signals in the storage unit 66 (Step S401). Then, the first mobile object 61 relays, to each of the second mobile objects 62, the received control signals including the control manipulation quantities via a communication unit 41 (Step S402). The communication unit 41 of the first mobile object 61 may relay, to each of the second mobile objects 62, the received control signals including control target values by broadcast communication. The communication unit 41 of the first mobile object 61 may also use, for example, short-range wireless communication such as Bluetooth (registered trademark) and ZigBee (registered trademark).

A motor control unit 42 of the first mobile object 61 controls a rotational speed of a motor in a motor unit 43, based on the control manipulation quantity addressed to the own vehicle and included in the control signal received from the remote-control device 30 (Step S403).

A motor control unit 42 of the second mobile object 62 controls a rotational speed of a motor in a motor unit 43, based on the control manipulation quantity addressed to the own vehicle and included in the control signal relayed from the first mobile object 61 (Step S404).

The second example embodiment is configured in such a way that: each of the second mobile objects 62 transmits, to the first mobile object 61, sensor information of the own vehicle; and the first mobile object 61 stores the received sensor information of the second mobile objects 62 in the storage unit 66, and transmits all the received pieces of sensor information to the remote-control device 30. The first mobile object 61 is configured to receive a control signal including a control manipulation quantity with respect to each of the second mobile objects 62 to be transmitted from the remote-control device 30, and store the control signals in the storage unit 66, and thereafter, transmit, to each of the second mobile objects 62, the control signals including the control manipulation quantities. Therefore, the remote-control device 30 according to the second example embodiment is configured to perform wireless communication only with the first mobile object 61. Thus, it is possible to suppress the number of transmissions and receptions of sensor information and a control signal between the remote-control device 30 and the mobile object 60. It is possible to suppress degradation of communication quality (such as a communication delay time, and a packet loss rate) pertaining to transmission and reception of sensor information and a control signal between the remote-control device 30 and the mobile object 60, since it is possible to lower the load of the communication network 10, even when the number of remote-controlled mobile objects 60 increases. Therefore, it is possible to improve responsiveness and stability of remote control from the remote-control device 30 to the mobile object 60.

The above-described second example embodiment has been described for a case where one of a plurality of mobile objects 60 is a first mobile object 61, the rest thereof are second mobile objects 62, and communication with the remote-control device 30 is performed via the first mobile object 61. Alternatively, the first mobile object 61 according to the second example embodiment may not be one but plural. For example, in the second example embodiment, it is assumed that three among a plurality of mobile objects 60 are first mobile objects 61, and the rest thereof are second mobile objects 62.

The remote-control device 30 may receive, from each of the first mobile objects 61, sensor information of all the second mobile objects 62, and collectively transmit, to two or more of the first mobile objects 61, control signals including control manipulation quantities of all the second mobile objects 62. Thereafter, the first mobile objects 61 that have received the control signals may transmit, to each of the second mobile objects 62, each of the control manipulation quantities. By configuring as described above, it is possible to improve reliability on attitude control of the mobile object 60 at a remote place, since redundancy of information to be transmitted and received is secured between the remote-control device 30 and the mobile object 60. The number of first mobile objects 61 may be selected according to a communication state between the remote-control device 30 and the mobile object 60 from an aspect that reliability is enhanced. Specifically, the number of the first mobile objects 61 may be increased according to deterioration of a communication state between the remote-control device 30 and the mobile object 60.

For example, in the second example embodiment, it is assumed that three among a plurality of mobile objects 60 are first mobile objects 61, and the rest thereof are second mobile objects 62. Further, it is assumed that each of the second mobile objects 62 belongs to any of the three first mobile objects 61. It is assumed that the remote-control device 30 has information in advance as to which one of the first mobile objects 61, each of the second mobile objects 62 belongs to.

The remote-control device 30 may receive, from each of the first mobile objects 61, sensor information of the second mobile object 62 belonging to each of the first mobile objects 61, and collectively transmit, to each of the first mobile objects 61, a control signal including a control manipulation quantity of the second mobile object 62 belonging to each of the first mobile objects 61. Thereafter, each of the first mobile objects 61 may transmit, to each of the second mobile objects 62 belonging to the own vehicle, the control manipulation quantity of each of the second mobile objects 62. By configuring as described above, it is possible to quickly perform attitude control of the mobile object 60 at a remote place, since it is possible to shorten a communication time between the remote-control device 30 and the mobile object 60, and a communication time between the first mobile object 61 and the second mobile object 62. The number of the first mobile objects 61 may be selected according to a frequency band to be allocated to communication between the remote-control device 30 and the mobile object 60 from an aspect that a communication time is shortened. Specifically, the number of the first mobile objects 61 may be increased according to a vacant state of a frequency band to be allocated to communication between the remote-control device 30 and the mobile object 60.

### (3) Third Example Embodiment

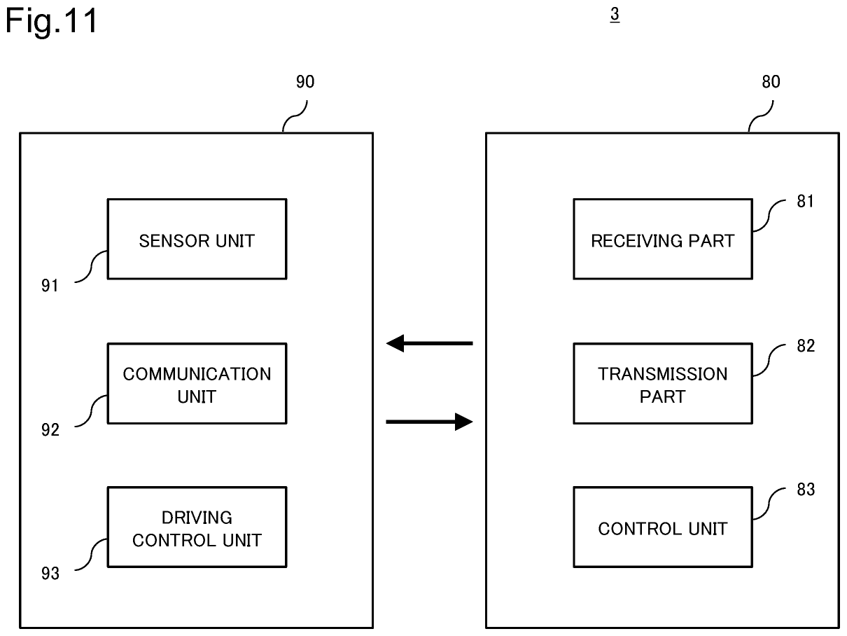

A remote-control system 3 according to a third example embodiment is described with reference to the drawings. FIG. 11 is a block diagram illustrating a configuration example of the remote-control system 3 according to the third example embodiment. As illustrated in FIG. 11, the remote-control system 3 according to the third example embodiment includes a remote-control device 80 and a mobile object 90.

The remote-control device 80 includes: a receiving part 81 for receiving sensor information to be transmitted from at least one mobile object 90; a control unit 83 for calculating a control manipulation quantity for manipulating the mobile object 90, based on attitude control information of a collective, which is set based on configuration information pertaining to a configuration of the collective in which the at least one mobile object 90 to be input is an element, and the received sensor information, and generating a control signal including the control manipulation quantity; and a transmission part 82 for transmitting the generated control signal to the mobile object 90.

The mobile object 90 includes a sensor unit 91 for acquiring sensor information, a wirelessly communicable communication unit 92 for transmitting the sensor information and receiving a control signal, and a driving control unit 93 for controlling a drive unit, based on the received control signal.

In the present example embodiment, providing, in the remote-control device 80, attitude control information of a collective, which is set based on configuration information pertaining to a configuration of the collective in which at least one mobile object 90 to be input is an element, and the control unit 83 for calculating a control manipulation quantity for manipulating the mobile object 90, and generating a control signal including the control manipulation quantity enables performing updating of an attitude control parameter and attitude control of the mobile object 90 in the remote control device 80. Thus, it is not necessary to secure personnel having expertise on site for updating the attitude control parameter of the mobile object 90. Therefore, in the remote-control system 3 according to the present example embodiment, it is possible to perform, in the remote-control device 80, updating of the attitude control parameter of the mobile object 90 accompanied by a configuration of a collective, without arranging personnel having expertise at a place where each of the mobile objects 90 is installed. Thus, the remote-control system 3 according to the present example embodiment is able to flexibly alter the configuration of the collective (unmanned aerial vehicles) in which the mobile object 90 is an element.

In each of the example embodiments according to the present invention, an attitude control device includes an attitude control program, and an attitude control parameter to be used when the program is operated. The example embodiments, however, are not limited to the above. The attitude control device may include a circuitry and the like.

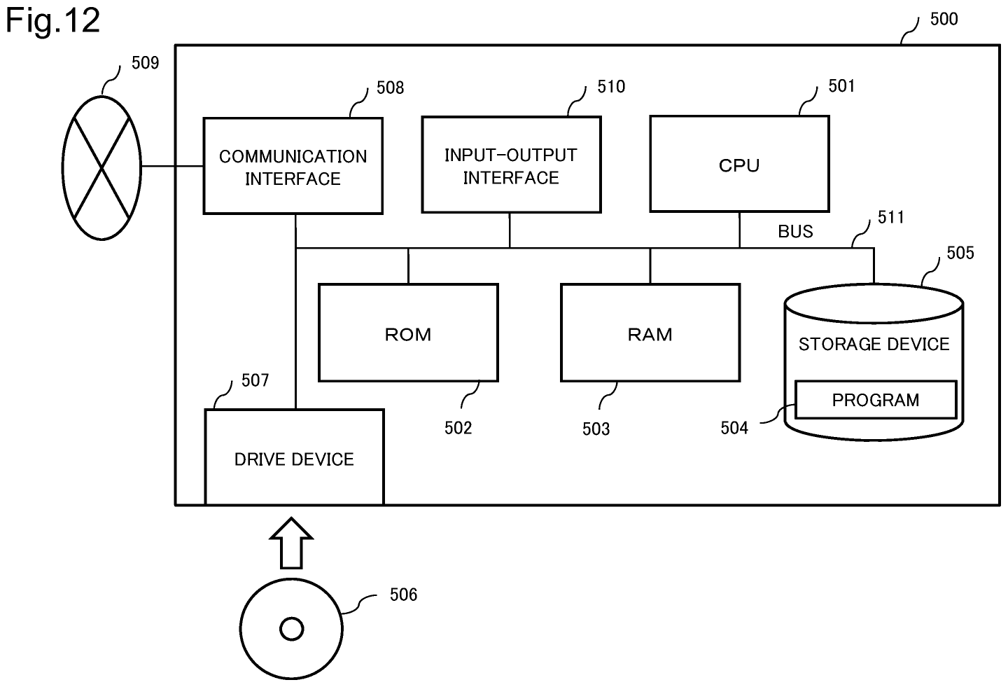

In each of the example embodiments according to the present invention, each constituent element of each device (system) indicates a function unit block. A part or all of each constituent element of each device (system) is achieved by any combination of an information processing device 500 as illustrated in FIG. 12, for example, and a program. The information processing device 500 includes the following configuration, as one example.
A central processing unit (CPU) 501
A read only memory (ROM) 502
A random access memory (RAM) 503
A program 504 to be loaded into the RAM 503
A storage device 505 for storing the program 504
A drive device 507 for performing reading and writing with respect to a recording medium 506
A communication interface 508 connected to a communication network 509
An input-output interface 510 for inputting and outputting data
A bus 511 for connecting constituent elements

Each of the constituent elements of each of the devices in each of the example embodiments is achieved by acquiring and executing the program 504 that achieves these functions by the CPU 501. The program 504 that achieves a function of each of the constituent elements of each of the devices is, for example, stored in advance in the storage device 505 or the RAM 503, and the CPU 501 reads the program as necessary. The program 504 may be supplied to the CPU 501 via the communication network 509, or may be stored in advance in the recording medium 506. The program may be read by the drive device 507, and supplied to the CPU 501.

Various modification examples are available as a method of achieving each of the devices. For example, each of the devices may be achieved by any individual combination of the information processing device 500 and a program, for each of the constituent elements. Alternatively, a plurality of constituent elements included in each of the devices may be achieved by any one combination of the information processing device 500 and a program.

A part or all of each of the constituent elements of each of the devices may be achieved by a general-purpose or dedicated circuitry including a processor and the like, or a combination thereof. These may be constituted of a single chip, or may be constituted of a plurality of chips connected via a bus. A part or all of each of the constituent elements of each of the devices may be achieved by a combination of the above-described circuitry and the like, and a program.

When a part or all of each of the constituent elements of each of the devices is achieved by a plurality of information processing devices, a circuitry, or the like, the plurality of information processing devices, the circuitry, or the like may be concentratedly disposed or may be distributively disposed. For example, the information processing devices, the circuitries, or the like may be achieved as a form in which each of the information processing devices, the circuitries, and the like is connected via a communication network such as a client-and-server system, and a cloud computing system.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2018-055827, filed on Mar. 23, 2018, the disclosure of which is incorporated herein in its entirety by reference.

### REFERENCE SIGNS LIST

1, 2, 3 Remote-control system
10 Communication network
11 Wireless base station device
30, 80 Remote-control device
31, 41, 92 Communication unit
32, 83 Control unit
32a Information acquisition unit
32b Attitude control processing unit
32c Control signal output unit
33, 66 Storage unit
40, 60, 90 Mobile object
42 Motor control unit
43 Motor unit
44, 91 Sensor unit
45 Battery unit
47 Mounting unit
50 Control target device
51, 52 Transport target object
61 First mobile object
62 Second mobile object
81 Receiving part
82 Transmission part
93 Driving control unit
101, 102 Wired link
103 Wireless link

1. A remote-control device comprising:
a receiving unit configured to receive sensor information to be transmitted from at least one mobile object via a communication network;
a control unit configured to calculate a control manipulation quantity for manipulating the mobile object, based on attitude control information pertaining to attitude control of a collective, which is set based on configuration information pertaining to a configuration of the collective in which the at least one mobile object to be input is an element, and the received sensor information, and configured to generate a control signal including the control manipulation quantity; and
a transmission unit configured to transmit the generated control signal to the mobile object.

2. The remote-control device according to claim 1, wherein
the control unit calculates the control manipulation quantity of each of a plurality of the mobile objects, the control manipulation quantity being capable of controlling the collective as a single unit.

3. The remote-control device according to claim 2, wherein
the transmission unit collectively transmits, to a part of the plurality of mobile objects, the control signals of the plurality of mobile objects.

4. The remote-control device according to claim 1, further comprising
a storage unit configured to store attitude control information being written by the control unit and pertaining to attitude control of the collective, wherein
the control unit includes:
an information acquisition unit configured to acquire the sensor information from the receiving unit, and attitude control information pertaining to attitude control of the collective from the storage unit;
an attitude control processing unit configured to calculate a control manipulation quantity for manipulating each of the mobile objects by using the acquired sensor information, and attitude control information pertaining to attitude control of the collective; and
a control signal output unit configured to generate a control signal including the control manipulation quantity, and configured to output the control signal to the transmission unit.

5. The remote-control device according to claim 1, wherein
the sensor information includes attitude information including at least any one of an angular velocity, an angular acceleration, and a tilt angle around each of a roll axis, a pitch axis, and a yaw axis, and includes GPS position information, rotation information of a motor, and battery information.

6. A mobile object comprising:
a sensor unit configured to acquire sensor information;
a wirelessly communicable communication unit configured to transmit the sensor information, and configured to receive a control signal; and
a driving control unit configured to control a drive unit, based on the received control signal.

7. The mobile object according to claim 6, further comprising
a mounting unit configured to fix an own vehicle to any transport target object, wherein
the mounting unit includes at least any one of a locking mechanism of hooking and locking to the transport target object, a nipping mechanism of nipping a part of the transport target object, a screw fixing mechanism of connecting and screw-fixing to the transport target object, and an adhesion mechanism of adhering to the transport target object.

8. A remote-control system comprising:
a remote-control device comprising:
a receiving unit configured to receive sensor information to be transmitted from at least one mobile object via a communication network;
a control unit configured to calculate a control manipulation quantity for manipulating the mobile object, based on attitude control information pertaining to attitude control of a collective, which is set based on configuration information pertaining to a configuration of the collective in which the at least one mobile object to be input is an element, and the received sensor information, and configured to generate a control signal including the control manipulation quantity; and
a transmission unit configured to transmit the generated control signal to the mobile object; and
the mobile object according to claim 6 that communicates with the remote-control device via a communication network.

9. A remote-control method comprising:
receiving sensor information to be transmitted from at least one mobile object via a communication network;
calculating a control manipulation quantity for manipulating the mobile object, based on attitude control information pertaining to attitude control of a collective, which is set based on configuration information pertaining to a configuration of the collective in which the at least one mobile object to be input is an element, and the received sensor information, and generating a control signal including the control manipulation quantity; and
transmitting the generated control signal to the mobile object.

10. (canceled)
